(19) United States
(12) Patent Application Publication
(10) Pub. No.: US 2008/0163969 A1
(43) Pub. Date: Jul. 10, 2008

(54) PNEUMATIC TIRE WITH BUTTRESSED SIDEWALL

(76) Inventor: Paul Bryan Maxwell, Kent, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/951,358

(22) Filed: Dec. 6, 2007

Related U.S. Application Data
(60) Provisional application No. 60/879,276, filed on Jan. 8, 2007.

(51) Int. Cl. B60C 15/00

(52) U.S. Cl. 152/523

(57) ABSTRACT

A pneumatic tire is disclosed having a carcass with a pair of beads and one or more plies extending between and wrapped around each bead. The tire further includes a plurality of reinforcing belts, a tread disposed radially outward of the carcass, and a pair of axially outer sidewalls extending radially inwards from the tread along the axially outer surface of the carcass and towards the beads. The lower sidewalls have a buttressed portion, wherein the outer diameter of the buttress portion preferably extends from the axially widest point of the sidewall down to the radially innermost portion of the tire.

This application claims the benefit of, and incorporates by reference, U.S. Provisional Application No. 60/879,276 filed Jan. 8, 2007.

### FIELD OF THE INVENTION

The invention relates in general to tires, and more particularly to off the road tires.

### BACKGROUND OF THE INVENTION

For certain off the road tires such as those used for rock climbing or other harsh conditions, it is desired to strengthen the sidewall and protect it from abrasions. For extreme rock climbing, it is desired to utilize the sidewalls as an additional gripping surface. The sidewalls may be used as an additional gripping surface when the user reduces the air volume in the tire, allowing the sidewalls to be part of the gripping surface.

Thus an improved off the road tire is desired with improved sidewall abrasion resistance.

### SUMMARY OF THE INVENTION

The invention provides in a first aspect a pneumatic tire having a carcass having a pair of beads and one or more plies extending between and wrapped around each bead. The tire further includes a plurality of reinforcing belts, a tread disposed radially outward of the carcass, and a pair of axially outer sidewalls extending radially inwards from the tread along the axially outer surface of the carcass and towards the beads. The sidewalls have a plurality of recessed portions and a plurality of buttressed portions, wherein the outer diameter of the buttressed portions and the outer diameter of the recessed portions are tangent above an intersection point on the sidewall, and wherein the outer diameter of the recessed portions is less than the outer diameter of the buttressed portions below said intersection point on the sidewall.

The invention provides in a second aspect a pneumatic tire having a carcass having a pair of beads and one or more plies extending between and wrapped around each bead.

The invention further includes a plurality of reinforcing belts, a tread disposed radially outward of the carcass, and a pair of axially outer sidewalls extending radially inwards from the tread along the axially outer surface of the carcass and towards the beads, wherein the sidewalls have a buttressed portion, wherein the outer diameter of the buttress portion extends from the axially widest point of the sidewall down to the radially innermost portion of the tire.

### DEFINITIONS

“Aspect Ratio” means the ratio of a tire's section height to its section width.

“Axial” and “axially” means the lines or directions that are parallel to the axis of rotation of the tire.

“Bead” or “Bead Core” means generally that part of the tire comprising an annular tensile member, the radially inner beads are associated with holding the tire to the rim being wrapped by ply cords and shaped, with or without other reinforcement elements such as flippers, chippers, apexes or fillers, toe guards and chafers.

“Belt Structure” or “Reinforcing Belts” means at least two annular layers or plies of parallel cords, woven or unwoven, underlying the tread, unanchored to the bead, and having both left and right cord angles in the range from 17° to 27° with respect to the equatorial plane of the tire.

“Bias Ply Tire” means that the reinforcing cords in the carcass ply extend diagonally across the tire from bead-to-bead at about 25-65° angle with respect to the equatorial plane of the tire, the ply cords running at opposite angles in alternate layers

“Breakers” or “Tire Breakers” means the same as belt or belt structure or reinforcement belts.

“Carcass” means a laminate of tire ply material and other tire components cut to length suitable for splicing, or already spliced, into a cylindrical or toroidal shape. Additional components may be added to the carcass prior to its being vulcanized to create the molded tire.

“Circumferential” means lines or directions extending along the perimeter of the surface of the annular tread perpendicular to the axial direction; it can also refer to the direction of the sets of adjacent circular curves whose radii define the axial curvature of the tread as viewed in cross section.

“Cord” means one of the reinforcement strands, including fibers, which are used to reinforce the plies.

“Inner Liner” means the layer or layers of elastomer or other material that form the inside surface of a tubeless tire and that contain the inflating fluid within the tire.

“Inserts” means the reinforcement typically used to reinforce the sidewalls of runflat-type tires; it also refers to the elastomeric insert that underlies the tread.

“Ply” means a cord-reinforced layer of elastomer-coated, radially deployed or otherwise parallel cords.

“Radial” and “radially” mean directions radially toward or away from the axis of rotation of the tire.

“Radial Ply Structure” means the one or more carcass plies or which at least one ply has reinforcing cords oriented at an angle of between 65° and 90° with respect to the equatorial plane of the tire.

“Radial Ply Tire” means a belted or circumferentially-restricted pneumatic tire in which the ply cords which extend from bead to bead are laid at cord angles between 65° and 90° with respect to the equatorial plane of the tire.

“Sidewall” means a portion of a tire between the tread and the bead.

“Laminate structure” means an unvulcanized structure made of one or more layers of tire or elastomer components such as the innerliner, sidewalls, and optional ply layer.

### BRIEF DESCRIPTION OF THE DRAWINGS

The invention will be described by way of example and with reference to the accompanying drawings in which:

FIG. 1 is a cross-sectional view of a off the road tire with the rim shown in phantom;

FIG. 2 is a side view of the tire shown in FIG. 1; and

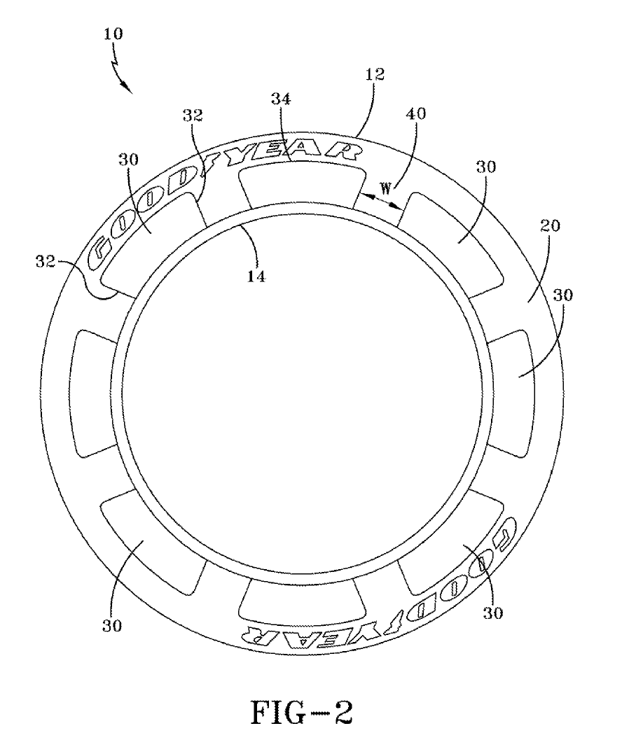

FIG. 3 is a side view of a second embodiment of an off the road tire.

### DETAILED DESCRIPTION OF THE INVENTION

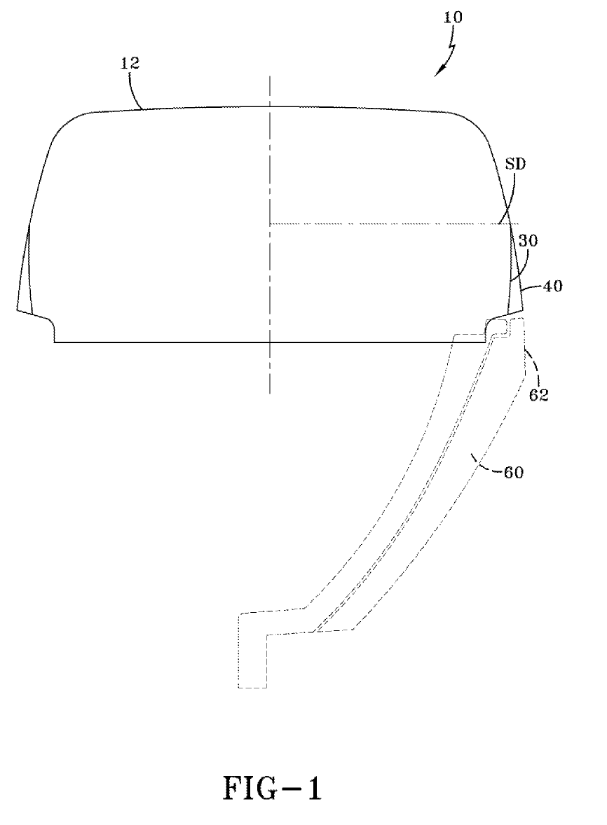

FIG. 1 illustrates a tire 10 of the present invention which may be used for example, in passenger vehicles, light truck and more typically off the road vehicles. The tire 10 has a tread portion 12 which extends circumferentially about the crown of the tire. The tire further includes a pair of axially spaced bead portions 14 each having an annular bead (not shown) disposed therein for seating on the flat of a rim. The tire 10 further comprises a carcass 16 having at least one ply of cords extending between the bead portions 14 and turned up around the bead cores. The tire further includes a belt package (not shown) disposed radially outside the carcass and inside the rubber tread 12.

The tire further comprises a pair of sidewalls 20 which extend radially inward from the tread towards the bead. The sidewalls 20 have axially outer convex shaped surfaces. The sidewalls of the tire further include a plurality of recessed portions 30. The recessed portions 30 may be approximately rectangular in shape (although any desired shape may be used), with radial ends 32 joined by edge 34. It is preferred that the radial ends 32 of the recessed portions extend substantially to the inner rim diameter 14. The edge 34 may be located as close to the tread as desired. Located between the recessed portions 30 are buttressed portions 40 which are disposed in an alternating pattern. The width W of the buttressed portions may be sized as desired to prevent tire abrasion. The recessed portions 30 have an outer diameter 31 which is tangent to the outer diameter of the buttressed portion in the upper sidewall portion of the tire. In the lower sidewall portion of the tire, preferably where the sidewall is the widest (SD), the recessed portion 30 curves inward of the radius of the buttressed portion. It is preferred that the buttressed portions 40 extend from the widest sidewall diameter to the inner rim diameter. The buttressed portions 40 serve to stiffen up the sidewall and protect the sidewall from abrasions.

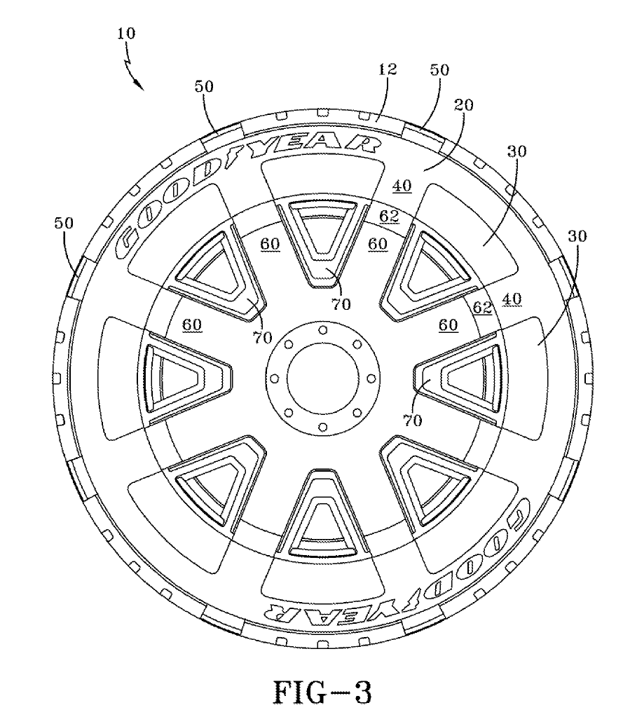

The tire assembly may further comprise an optional rim 60, wherein the rim has a projection 62 which aligns with buttressed portions 40. The rim further comprises a plurality of buttressed portions 62 which alternate with recessed portions 70. As shown in FIG. 3, in an alternate embodiment of the tire, the buttressed portions 40 align with axially oriented tire grooves 50.

In another embodiment of the invention (not shown), the tire has a single continuous lower buttressed portion and no recessed portions, wherein the buttressed portion has a first end located at or below the axially widest part of the tire and wherein the buttressed portion has a second end located at the lower rim. Alternatively, the first end of the buttressed portion may be located above the axially widest portion of the tire.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having a carcass having a pair of beads and one or more plies extending between and wrapped around each bead, and a plurality of reinforcing belts, and a tread disposed radially outward of the carcass, a pair of axially outer sidewalls extending radially inwards from the tread along the axially outer surface of the carcass and towards the beads, wherein the sidewalls have a plurality of recessed portions and a plurality of buttressed portions, wherein the outer diameter of the buttressed portions and the outer diameter of the recessed portions are tangent above an intersection point on the sidewall, and wherein the outer diameter of the recessed portions is less than the outer diameter of the buttressed portions below said intersection point on the sidewall.

2. The pneumatic tire of claim 1 wherein the intersection point is located at about the midpoint of the sidewall.

3. The pneumatic tire of claim 1 wherein the intersection point is located at about the axially widest of the sidewall.

4. A pneumatic tire having a carcass having a pair of beads and one or more plies extending between and wrapped around each bead, and a plurality of reinforcing belts, and a tread disposed radially outward of the carcass, a pair of axially outer sidewalls extending radially inwards from the tread along the axially outer surface of the carcass and towards the beads, wherein the sidewalls have a buttressed portion, wherein the outer diameter of the buttress portion extends from the axially widest point of the sidewall down to the radially innermost portion of the tire.

5. The pneumatic tire of claim 4 further comprising a plurality of buttressed portions and a plurality of recessed portions.
